(19) United States
(12) Patent Application Publication
(10) Pub. No.: US 2009/0019711 A2
(43) Pub. Date: Jan. 22, 2009

(54) MODEL ELEMENTARY FLEXOR

(75) Inventor: Anatoliy MILKA, Kharkov (UA)

Correspondence Address: DANIEL B. SCHEIN, PH.D., ESQ., INC., P. O. BOX 68128, Virginia Beach, VA, 23471, UNITED STATES, 757-965-5218, 757-965-6775, shinelegal@aol.com

(73) Assignee: CLOSE JOINT-STOCK COMPANY "GST", KHARKOV (US)

(21) Appl. No.: 11/795,666

(22) Filed: Jul. 19, 2007

(30) Foreign Application Priority Data
Jan. 19, 2005 (UA) A2005 00664

(51) Int. Cl. G01B 21/00; E04B 1/344

(52) U.S. Cl. 33/1 G; 52/71

(57) ABSTRACT

The model elementary flexor is a polyhedral panel represented by a four-angle star-like pyramid which is formed by thin elastic three-angle faces with hinge junctions. It has two symmetry planes which intersect the petals of flexor. An essential geometric property of the flexor is following: when the middle polyhedron is projected into the plane of the boundary, then each face is mapped to a triangle whose doubled intrinsic and extrinsic angles adjacent to the boundary are equal to π/2−α Ta π/2+α respectively, where α is the third angle of the three-angle and it belongs to the interval (0,π/2). As consequence, the presented device is more general than its prototype, the right star-like pyramid “Model ideal flexor”, disclosed in UA Patent No. 54692. The invented device belongs to various areas of technique and industry where polyhedral shells with freely changed geometric forms are applied: architecture, aircraft construction, shipbuilding and precise instrument-making. Under small cross loads the panel suffers a non-rigid loss of stability, which is either soft or slow in terms of the dynamical systems theory, and it goes to an adjacent state infinitesimally close to the original equilibrium state, provided that the boundary always slips along its plane. After that, the panel is subject to an overcritical deformation, which is good approximated by an unusual linear bending of its middle polyhedron, as it is predicted by the geometric theory of shells. The deformation is well determined, it goes with a large cross flexure, which is comparable with sizes of the panel, and may be completely controlled numerically. The faces of the panel under the described deformation move approximately as solid plates, whereas the applied efforts discharged basically in hinge junctions joining faces. Such a way to lose the stability, which has been conjectured by L. Euler's static criterion, was unknown in the literature and in practical applications, it was considered just as an abstract idea.

1. The presented invention belongs to various areas of technique and industry where polyhedral shells are applied. First of all, it concerns with architecture, aircraft construction, shipbuilding and precise instrument-making. It may be used for design of construction with changeable geometric forms. Namely, thin elastic polyhedral shells of constant width are considered. The middle surfaces of these shells are polyhedra. In various applications, as well as in theoretical and practical computations, shells are usually represented by corresponding middle surfaces. Polyhedral shells are applied basically in the architecture [1,2]. They are also used in other technical areas where finite elements methods are applied to design constructions. A growing importance of polyhedral shells is confirmed by the following air forces example: the US aircraft F-117A has a fuselage just of polyhedral form that is one of its essential technological merits [3].

2. A principal requirement for any shell, particularly—for a polyhedral shell, is its stability in practical situations. The subject of the presented invention leads to another constructions. We are dealing with polyhedral shells which admit large controlled changes of geometric forms under small loads. Similar movable constructions are unknown in the technical applications. An exceptional example here is represented by physical models of non-rigid simple spherical polyhedron-flexors and rigid open right star-like pyramids, which are well-known to geometers. Recall that a polyhedron is said to be simple if it has no self-intersections. A polyhedron is referred to as non-rigid, if it admits continuous bendings as defined by A. Cauchy. It means that the faces of the polyhedron are moving as solid plates, so the lengths of edges are fixed, whereas the dihedral angles may be varied. On the other hand, in more general sense a bending is defined as an isometric deformation of a surface. The notion “flexor” was introduced by R. Connelly who proved the existence of simple polyhedra of spherical type which admit bendings. A physical model of such a flexor, which is represented by a thin shell of constant width, is called a theoretical flexor. In technical literatures there are various other notions which correspond to the notion of theoretical flexor—“mechanism”, “kinematical mechanism” (rus), “true mechanism” (fr), “precise mechanism” (eng). In practice the word “mechanism” is often relied with the phenomenon of fracture of constructions. On the other hand, the existence of a “mechanism” itself is not discussed, since a shell is applied only if its stability is predicted by usual experimental methods.

Up to now only three polyhedron-flexors of Connelly's type are discovered. They were found in 1978 by R. Connelly (18 vertices), N. Keuper an P. Dehlin (11 vertices), K. Stefen (9 vertices) [4]. It is known from the experience that polyhedral shells constructed with help of these flexors, i.e. theoretical flexors, admit large free deformations without visible distortions of materials inside the class of polyhedral surfaces; here a deformation is free, if it is resulted by sufficiently small loads. Such transformations of a polyhedral shell are well defined and invertible, they quite precisely reproduce some bendings of the middle surfaces of the shell. The mentioned properties of deformations have following concrete consequences. Under small negligible loads the shell is continuously deformed, the amplitude of the deformation is comparable with sizes of the shell. The faces of the shell rotate along edges like to solid plates. Tensions which arise in the shell because of applied loads are discharged in small neighborhoods of edges, so the whole system of edges of the shell remains stable. In this case the shell is referred to as geometrically bendable in the class of polyhedra. This definition deals with closed shells as well as with open shells or panels. Moreover, it may be applied to shells with rigid middle surfaces, which makes it of principal importance.

The ability of theoretic flexors to be bendable is known from the experience, it is caused by the non-rigidity of middle polyhedral surfaces of shells. Some shells with rigid middle polyhedral surfaces, which are geometrically bendable like to theoretical flexors, were recently discovered by the author in [5,6,7] with help of particular polyhedra, star-like pyramid. It is naturally to call such polyhedra model flexors. As result of the cited articles, the author obtained UA Patent No. 54692. The word “ideal” indicates some ideal kind of the loss of shell's stability, which has been predicted by L. Euler and considered in the literature as a loss of stability in “small”[8]. This device has no analogues, since its exceptional technical properties are based on a new surprising phenomenon in the theory of shells, which was discovered by the author. Namely, it was discovered that a shell with rigid middle surface may admit non-rigid, either soft or slow, loss of stability. It is really surprising, since in mechanics the following principle was commonly applied up to now: a thin shell with rigid middle surface is stable in practice [1,2]. The described model ideal flexors will serve as prototype of the new device that is presented here, so it will be useful to recall their formula.

“A model ideal flexor is represented by a right star-like pyramid or by a star-like tent polyhedral panel made from thin elastic faces joined by hinges, provided that the panel inherit the symmetry and convexity properties of the base star. The panel has a plane boundary, which is adjacent to triangle and rectangular lateral faces; besides it has a central element in the form of vertex, edge or face, which is also adjacent to the lateral faces. When the middle polyhedron of the panel is projected in the plane of the boundary, every lateral face is projected into a triangle whose doubled intrinsic and extrinsic angles are equal to π/2−α and π/2+α respectively, there α=π/n is the third angle of the triangle, here n>2 is integer. As consequence, a well determined, free, continuous deformability of the flexor in the class of polyhedral panels is assured, it is caused by a non-rigid, either soft or slow, loss of stability, provided that the boundary of the panel slides in its plane. The sizes of the panel are general and independent, they are viewed as space parameters.”

Let us compare the presented device and its prototype. We see that they essentially differ only by the ranges of values which the angle α may have. The formula of the prototype contains the restriction α=π/n, where n is integer. This undesirable restriction arises since the model ideal flexors were constructed with help of right pyramids. The formula of the presented device does not contain this restriction, the angle α may take any value in the interval (0,π/2). All the other properties of devices in question coincide, especially it concerns the aim of the discovery and physical causes of free bendability of considered shells. In order to see that, one can analyze approximating mathematical bendings of middle polyhedral surfaces of petals of corresponding star-like pyramids. Here we apply the following fundamental principle of isometry formulated by A. V. Pogorelov for general thin shells: deformations of a loaded thin shell are completely determined by appropriate bendings of its middle surface [9].

The mentioned appropriate bendings for star-like pyramids are described by some unified formulae, which were discussed for the first time in [10]. They are found not mathematically but from qualitative principles of experimental mechanics about generic loss of stability of shells which presented by A. S. Volmir in [11]. Corresponding discussions and justifications were presented in a plenary communication given by the author on an international geometric conference [12]. As for the prototype flexors, appropriate bendings of their middle surfaces have been found firstly for some particular right pyramids only. Remark that the formula of the presented device implicitly contains a new essential property, which consists in some possibility to control technical mistakes of approximation in the process of the technical realization of the device; such a possibility were not included in the prototype's formula. Besides remark that some elements of right pyramids, petals and semi-petals, may be used to construct more complicated polyhedral panels, which represent model flexors. The same is true for the presented device. Thus we see that the new formula is more general, meaningful and profound then the formula of the prototype, it describes a new class of model ideal flexors.

3. The principal problem that we solve here is to construct a new series of model flexors in the form of technologically elementary shells, which may be used for design and create various constructions with continuously and freely deformable geometric forms. The solution is given by means of a particular polyhedral shell in the form of a four-angle star-like pyramid which consists of thin elastic faces connected by hinges. The pyramid has two planes of symmetry which intersect the petals of the pyramid. The mentioned geometric properties determine the pyramid. Remark that there are various type of hinges known in techniques [13]: usual cylindrical hinges called kinematical pairs and kinematical chains of cylindrical hinges, fold-hinges (thin bends of materials of shells), bearing-hinges, rubber-steel hinges etc. What kind of hinges has to be used in every concrete case is solved by specialists after detailed experimental and theoretical analysis.

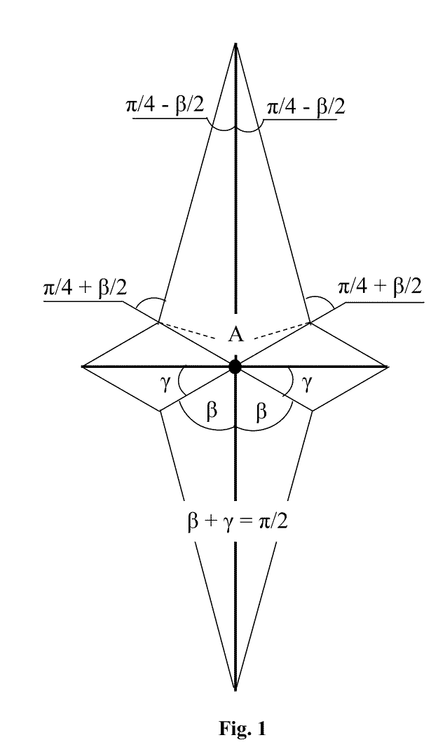

The projection of the middle polyhedron of the shell in question is shown in FIG. 1, it is a four-angle star. The central element of the polyhedron is the vertex A whose projection is marked by the thick point. The star is symmetric with respect to two mutually orthogonal straight lines, which a lines of symmetry for its petals too. Thus every petal of the star is formed by two equal triangles joined along a common diagonal side which is the projection of a convex inclined edge of the pyramid. Adjacent petals are separated by segments which are the projections of concave inclined edges of the pyramid. For every elementary triangle of the star, its doubled intrinsic and extrinsic angles adjacent to the star's contour are equal to π/2−α and π/2+α respectively, the third angle is equal just to α. All the mentioned angles are shown on FIG. 1, where only one petal is demonstrated. Corresponding angles of the elementary triangle are denoted by β and γ. In the general situation the angles α, β and γ take arbitrary values in (0,π/2), only the natural restriction β+γ=π/2 has to be satisfied.

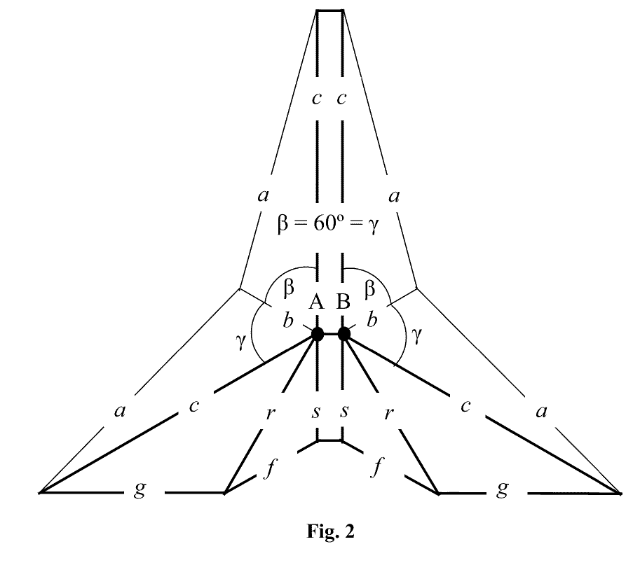

The projection of the middle surfaces of a composed prototype panel is represented in FIG. 2. The panel is constructed with the help of a model flexor in the form of the right triangle star-like pyramid. The construction is fulfilled as follows: every two faces of adjacent petals of the triangle pyramid are replaced by two semi-petals of six-angles pyramids, their projections are represented by isosceles triangles; next two rectangle faces are inserted along the symmetry plane. The projection of added triangle and rectangle faces are plotted in FIG. 2 by thick lines. The central element of the pyramid is its edge AB. The symbols β and γ denote corresponding angles of triangles of the star. It is easy to see that β=γ=60°. The sides of faces of the triangle pyramid are denoted by a, b, c, whereas r, g, s, f stand for the sides of the six-angle pyramid. It follows from the Formula of the presented device, that we can considerably change the configuration of the panel in question. Namely, one can replace semi-petals of the triangle pyramid-flexor by semi-petals of the four-angle pyramid-flexor. A unique condition is that the angles β and γ have to satisfy the equality β+γ=120°; for instance, one can fix β=65° and γ=55°. Thus one can construct a one-parametric family of new composed model flexors.

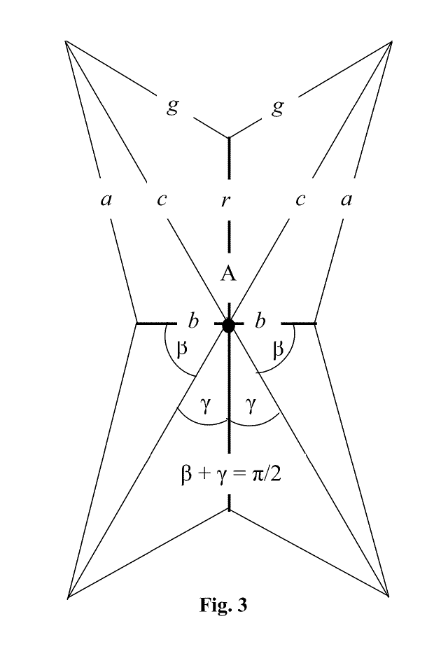

The projection of the middle surface of a four-angle star-like pyramid, which is a model flexor, is shown in FIG. 3. This pyramid has two planes of symmetry which don't intersect the petals. The semi-petals of the pyramid in question are semi-petals of model elementary flexors, four-angle star-like pyramids. In FIG. 3 the projections of the edges of middle polyhedron are marked as well as the corresponding angles β and γ. Two lines of symmetry of the four-angle star contain the projection of concave edges of the polyhedron. The central element of the polyhedron is its vertex A. The angles β and γ satisfy the equality β+γ=π/2.

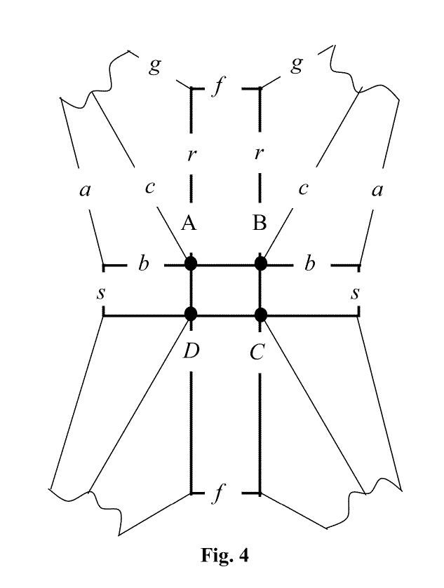

The projection of the middle surface of a composed model flexor is shown in FIG. 4. This shell is obtained from the shell represented in FIG. 3 by introducing inclined rectangular faces along the planes of symmetry and a central element, represented in FIG. 4 by the rectangle ABCD, which is parallel to the boundary plane of the pyramid. The sizes of the central element are determined by the length s and f of corresponding sides of rectangles.

4. The main point of the presented discovery is the creation of elementary movable constructions which realize the mentioned axiomatic principle of from the geometric theory of thin elastic shells by A. V. Pogorelov [9]: deformability properties of a technical construction are completely determined by characteristics of corresponding bendings of its middle surface. A solution is given in the form of a four-angle star-like pyramid, whose middle polyhedral surface is shown in FIG. 1. Some more complicated model flexor represented by shells composed from elements of elementary star-like pyramids, petals and semi-petals, but always with plane boundaries are shown in FIGS. 2, 3, 4. The middle polyhedron of the four-angle star-like pyramid in question, as well as the middle surfaces of composed model flexors, does not admit any bendings, as defined by A. Cauchy, with plane sliding of the boundary [5]. On the other hand the same polyhedrons, elementary and composed, admit continuous bendings with breaks of faces either near to the central element and concave edges or near to the boundary. For instance, the dotted lines in FIG. 1 represent the moving lines of break for the faces of one petal. Such deformations of polyhedra are referred to as linear bendings, this notion is well known in geometry [5]. The bending is controlled by two parameters: a phase, which is equal to a generalized deviation of new vertices of break segments from the original vertices of polyhedron, and the sag amplitude. The phase is defined with sign, the “minus” means that the bended polyhedron has self-intersections. When the bending starts, the phase is approximately equal to the square of amplitude. In terms of the classical analytical theory of dynamical systems such deformations are referred to as non-rigid, either soft or slow, losses of stability, see V. Arnold's monograph [14]. The existence of the deformation in question is assured by particular relations imposed on the angles of elementary triangles in the projection of the middle polyhedron. How the middle polyhedron losses the stability, softly or slowly, and how the edges of polyhedron break, all these questions depend on the choice of controlling parameters, the sizes of the pyramid, and may be specified in experiments.

5. Technical Result.

Under a small transversal load the considered model flexor represented by a particular four-angle star-like pyramidal shell suffers a non-rigid loss of stability, and at a bifurcation moment it goes to an adjacent state infinitesimally close to the original equilibrium state, provided that the boundary of the pyramid slides in its plane. These facts confirm that following the static criterion by L. Euler the panel in question represents an ideal shell which admits a loss of stability “in small”. During the overcritical deformation of the panel with slow excitations of the phase, the amplitude grows quite fast, so the space configuration of the panel suffers essential changes, thus the panel is geometrically bended in the class of polyhedral panels. This phenomenon directly leads to various applications of elements of the presented device, petals and semi-petals, to the creation of new model flexors. In particular, it may be applied to design new membranes in welded steel sylphons with symmetric and non-symmetric profiles of goffers [15,16]. Flexability properties of the panels represented in FIGS. 3, 4 reveal in the same physical conditions and characteristics as it is for the model elementary flexor.

Hinge Sylphon.

Let us consider a closed polyhedral shell with hinge joins of faces, which has a plane of symmetry such that their symmetry elements are panels equal to the panel shown in FIG. 4. Remove all the central panels of composing panels. As result, we obtain a polyhedral shell which is just tube sylphon S with one goffer, an analogue of a welded sylphon. If we join flange rings to the boundary of the sylphons by hinges, we will have a device which can be applied in industry as a lens compensator of heat tensions in technological pipes [15]. Assembling by hinges various packets of sylphons identical to the sylphon S, we will have general goffered tube shells with arbitrary quantity of gofers. It is natural to call them hinge sylphons. Clearly hinge sylphons may be used as sensitive elements in precise devices which works in view of the force compensation principle [16]. One may hope that hinge sylphons are at least equal to welded sylphons by technical characteristics. They are stable with respect to axe bendings, the goffer surfaces don't meet. Moreover their producing is much more simple as well as mathematical and computer analysis.

The panel represented in FIG. 4 has another important application in industry. Namely, it may be used to design new technical shock-absorbers. An essential effect may be achieved by appropriate choices of hinges to join faces of panels.

Technical Realization of the Sylphon S.

The material: stainless steels, chrome-based or nickel-based alloys, titan-based alloys, for instance: steel 4×13, alloy E1702, alloy 36XTIO [16]; the types of hinges are chosen experimentally. The geometric sizes in mm are following: the sylphon S has two lines of symmetry, a=87, b=36, c=100, r=61.3, g=56, the values of s and f are chosen with respect to technical problems to solve, the length of S along its axe is equal to 50; errors has to be less than 0.1 MM. The theoretical free sag of the sylphon (stroke of work, [16, p.p. 98,129]) during compressing/tension processes under small loads along the axe is approximately equal to ¼ of the length. This result is experimentally demonstrated with the help of a corresponding model made from a carton of width 0.25 mm. There are essential reasons to hope that the sylphon S made from a constructing material will have the stroke of work equal approximately to 10 MM.

### APPENDIX

The discovery of model flexors leads to a new phenomenon in the mechanics of overcritical large deformations of solid bodies. It may be directly verified with help of models made from widely used materials—cartons, plastics, mailar, etc For this purpose, one may construct a concrete closed polyhedral shell in the form of a planer which is composed by two copies of the panel shown in FIG. 2 of Ch. 3, the concrete values of parameters may be fixed as follows: a=87, b=36, c=100, r=61.3, g=56, s=40, f=32.3. A similar carton shell which has been made by the author in 1997, were exposed to numerous cycles of bendings and still remains in a good state.

### REFERENCES

1. Janos Baracs, Henry Crapo, Ivo Rosenberg et Walter Whiteley. Mathematiques et architecture. “La topologie structurale”, No 41-42—Montreal, 1978.
2. Modern space constructions: reference book. Edit. by Yu. A. Dykhovichniy and E. Z. Zhukovskiy.—“Vysshaya shkola”, Moscow, 1991.
3. Modern war aircraft: reference book. Edit. by N. I. Riabinkin.—“Elaida”, Minsk, 1997.
4. I. Kh. Sabitov. Local theory of bendings of surfaces. “Itogi nauki i techniki. Seriya: sovremennie problemy matematiki”, v. 48. VINITI, Moscow, 1989.
5. A. D. Milka. Bendings of surfaces, bifurcation of dynamical systems and stability of shells. Intern. Conf. “Discrete geometry and applications”, Moscow, January 2001.
6. A. D. Milka. The Star-like Pyramids of Alexandrov and S. M. Vladimirova. Siberian Adv. Math., v. 12 No 2, p. 56-72, 2002, New York, USA.
7. A. D. Milka. Bending of Surfaces, Bifurcation, Dynamical Systems and Stability of Shells. International Congress of Mathematicians. Abstracts. August 2002, Beijing, China.
8. E. I. Grygolyuk, V. V. Kabanov. Stability of shells. “Nauka”, Moscow, 1978.
9. A. V. Pogorelov. Bendings of surfaces and stability of shells. “Naukova dumka”, Kiev, 1998.
10. A. D. Milka. Linear bending of star-like pyramids. C. R. Mecanique 331 (2003) 805-810, Paris, France.
11. A. S. Volmir. Stability of elastic systems. “Fizmatghiz”, Moscow, 1963.
12. A. D. Milka. Geometry of bendings of star-like pyramidal shells. Intern. Conf. “Geomeetry in Odessa—2004”, Odessa, May 2004.
13. Mechanisms: reference book. Edit. by S. N. Kozhevnikov. “Mashinostroenie”, Moscow, 1976.
14. V. I. Arnold Theory of catastrophes. “Nauka”, Moskow, 1990.
15. M. I. Sevastiyanov. Technological pipes of oil industry. “Khimiya”, Moscow, 1972.
16. L. E. Andreeva and al. Sylphons. Calculations and design. “Mashinostroenie”, Moscow, 1975.

1-2. (canceled)

3. A model elementary flexor in a form of four-angle star-like pyramid formed by thin elastic faces with hinge joints, having two symmetry planes which intersect the petals of flexor, wherein each face in the projection of the middle polyhedron into the plane of the boundary is mapped to a triangle whose doubled intrinsic and extrinsic angles adjacent to the boundary are equal to π/2−α and π/2+α respectively, for provide its well-defined continuous free deformability inside the class of polyhedral panels with plane sliding of the boundary and with large transversal deflection, which is caused by a non-rigid, either soft or slow, loss of stability, characterized in that, each of angles α, the third angle of the corresponding triangle, is laid within the interval (0,π/2), during which the sizes in the plane and the height of the flexor are general independent parameters.
